(19) United States
(12) Patent Application Publication
(10) Pub. No.: US 2008/0183494 A1
(43) Pub. Date: Jul. 31, 2008

(54) SYSTEM AND METHOD FOR AUTONOMOUS DATA GATHERING AND INTELLIGENT ASSESSMENT

(75) Inventors: PAUL EDWARD CUDDIHY, BALLSTON LAKE, NY (US); DAVID WAYNE DUCKERT, MENOMONEE FALLS, WI (US); JENNY MARIE WEISENBERG, NISKAYUNA, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/669,291

(22) Filed: Jan. 31, 2007

(51) Int. Cl. G06Q 50/00

(52) U.S. Cl. 705/2

(57) ABSTRACT

A technique is provided for assessing a user. The technique includes automatically querying the user and relaying user responses to an assessment subsystem. The technique also includes automatically and intelligently assessing the user based on the user responses and generating questions for subsequent query based at least in part on the user responses and the assessment.

### BACKGROUND

The invention relates generally to data gathering and assessment, and more specifically to a technique for automatically gathering data and intelligently assessing the gathered data. In particular, the invention relates to monitoring health of an individual by automatically and remotely gathering health related data and intelligently assessing the same.

A wide variety of applications require gathering data from a user and/or a sample population and assessing the same to derive a useful conclusion. For example, in healthcare applications, it may be required to periodically assess a patient's health by gathering health related data from the patient. Such assessment of health related quality of life (HRQL) of the patient is typically carried out at the hospital during patient discharge and infrequently thereafter at home. However, patients with chronic diseases such as congestive heart failure (CHF) may benefit from being regularly monitored and assessed on a more frequent basis. Formal and family caregivers who monitor the condition of the patient (e.g., if the patient's activity level is reduced, spends excessive time in bed, does not get dressed, or becomes tired easily) may not notice these symptoms, especially if they occur gradually over a period of time. Patients who monitor themselves and self-report their condition often do so in an inconsistent manner. Consequently, a patient experiencing declining health may go unnoticed until an adverse acute event occurs. In many cases, patients tend to deteriorate to the point that they require expensive and inconvenient trips to the emergency department of a hospital.

Subjectivity by the patient or caregiver may cause the patient to request medical attention too frequently or infrequently. The requests for attention and visits to medical professionals when not needed consume resources in the health system that could deny timely care to other patients. In addition, the unneeded visits take time and effort of the patient and may expose the patient to additional dangers in making the visit. Waiting too long before receiving medical attention may result in an expensive and more dangerous re-hospitalization or an acute medical event.

Measurements from in-home monitoring devices are typically taken once a day and may miss symptoms like reduced sleep or worsening fatigue. Futhermore, the introduction of measuring devices into the home to collect physiological data can create burdens on the daily routine of the patient. Traditional measurements often involve cumbersome equipment. Being tethered to a measuring device may restrict the patient from movement that may worsen the medical condition. The patient may feel awkward in moving and become less motivated to maintain a healthy activity level. The patient may feel less agile and risk falling. If the patient is disconnected from the device while making movements, then data may be lost or the monitoring of the patient will be compromised. The disconnection could occur by choice of the patient to allow the patient to perform a move unencumbered or accidentally when the patient moves around, resulting in a malfunction or a lost measurement. Patient self-reporting can provide important information about the patient's status without having to introduce such device related problems.

Self-assessed health related quality of life (HRQL) has been able to predict the risk of mortality and rehospitalization when the patient is at home. For example, as shown in FIG. 1, the current technique for assessing the health related quality of life of a patient at home includes administering a HRQL questionnaire via an in-home device, then transmitting and displaying the answers to a healthcare professional who can intervene if the patient reports a deteriorating condition. However, the current technique fails to automatically assess the health of the patient and requires manual monitoring by a health care professional. Additionally, the techniques may administer too many questions and may cause or contribute to noncompliance. For example, the technique involves asking the same set of health related questions each time the patient is queried and then scoring the responses in the same way. Since the questions are always the same regardless of the patient's previous answers or health status, the patients tend to grow tired of the questions and not consider them carefully, thereby leading to inaccurate answers or poor compliance by the patients. Thus, the current techniques are not very effective in assessing the health related quality of life (HRQL) of a patient.

It would therefore be desirable to provide an efficient and automated technique for monitoring health of an individual by administering HRQL questions and evaluating the responses. An effective automated system, that is triggered by screening questions or other relevant data, would make it possible to gather health related quality of life data more frequently and to identify problems earlier.

### BRIEF DESCRIPTION

Briefly, in accordance with one of the embodiments, a system is provided for assessing a user. The system includes one or more devices for querying the user and relaying user responses to an assessment subsystem. The assessment subsystem is configured to intelligently assess the user based on the user responses and to intelligently generate questions for subsequent query based at least in part on the user responses and the assessment.

In accordance with another embodiment, a system is provided for assessing health related quality of life (HRQL) of an individual. The system includes one or more devices for querying the individual and relaying individual responses to an assessment subsystem. The assessment subsystem is configured to intelligently assess the HRQL of the individual by automatically scoring the individual responses to generate a score and translating the score into a risk assessment.

In accordance with an additional embodiment, a method is provided for assessing a user. The method provides for automatically querying the user and relaying user responses to an assessment subsystem. The method also provides for automatically and intelligently assessing the user based on the user responses and generating questions for subsequent query based at least in part on the user responses and the assessment. Systems and computer programs that afford such functionality may be provided.

In accordance with a further embodiment, a method is provided for assessing health related quality of life (HRQL) of an individual. The method provides for automatically querying the individual and relaying individual responses to an assessment subsystem. The method also provides for automatically and intelligently assessing the HRQL of the individual by automatically scoring the individual responses to generate a score and translating the score into a risk assessment. Here again, systems and computer programs affording such functionality may be provided.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a traditional system for remotely assessing the health related quality of life (HRQL) of a patient;

FIG. 2 is a block diagram of a system for remotely assessing a user in accordance with aspects of the present technique;

FIG. 3 is a block diagram of a system for assessing the health related quality of life (HRQL) of a patient in accordance with aspects of the present technique; and

FIG. 4 is a flowchart depicting a process for assessing a user in accordance with aspects of the present technique.

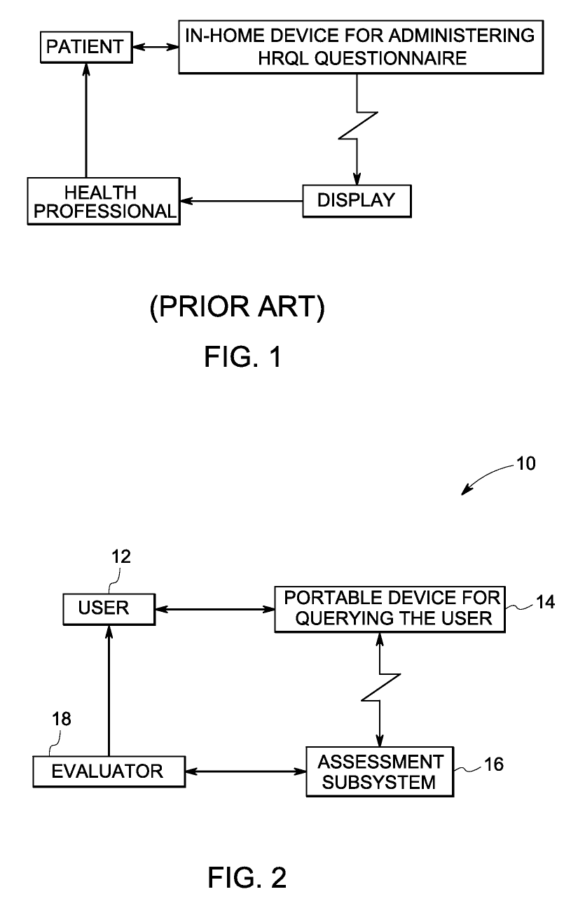

### DETAILED DESCRIPTION

The present techniques are generally directed to automatically gathering data and intelligently assessing the same. Such data gathering and assessment techniques may be useful in a variety of monitoring and surveying applications, such as evaluating health of an individual, conducting a survey on a sample population to check awareness of the population in certain context (health related awareness, environmental awareness, social awareness, political inclination, etc.), and so forth. Though the present discussion provides examples in context of health monitoring and evaluation of health related quality of life (HRQL) of an individual, one of ordinary skill in the art will readily comprehend that the application in other contexts is well within the scope of the present techniques.

Referring now to FIG. 2, a block diagram of a system 10 for assessing a user 12 is illustrated. The system 10 comprises one or more devices 14 configured to receive a set of questions from an assessment subsystem 16 for querying the user 12 and to relay user responses to the assessment subsystem 16. In certain embodiment, the assessment subsystem 16 may be remotely located from the one or more query devices 14. The assessment subsystem 16 and the devices 14 may interact with each other over a wired/wireless communication network/channel. The assessment subsystem 16 is configured to intelligently assess the user 12 based on the user responses. Additionally, the assessment subsystem 16 is configured to intelligently generate questions for subsequent query based on the user response and the assessment. In particular, the questions are generated based on responses to previous queries, type of assessment, previous assessments, and/or other data related to the user 12. The number of questions in the set and the questions are predetermined or determined each time based on one or more responses to previous queries, previous assessments, other data related to the user, and/or user's tolerance to the number of questions.

The assessment subsystem 16 is configured to intelligently assess the user by automatically scoring the user responses to generate a score and translating the score into an assessment. The score may be translated to generate the assessment by referring to a predefined look-up table, a correlation between change in score and change in assessment based on one or more previous assessments, a correlation between score and assessment based on population study, and/or other data related to the user 12. It should be noted that the score and the corresponding assessment may be continuously updated in a database for future reference. The assessment subsystem 16 is further configured to display the score and the corresponding assessment to an evaluator 18, if appropriate, rank the user based on the assessment, and alert the evaluator 18 based on the assessment. The evaluator 18 may then interact with the user 12 and take any required action based on the assessment.

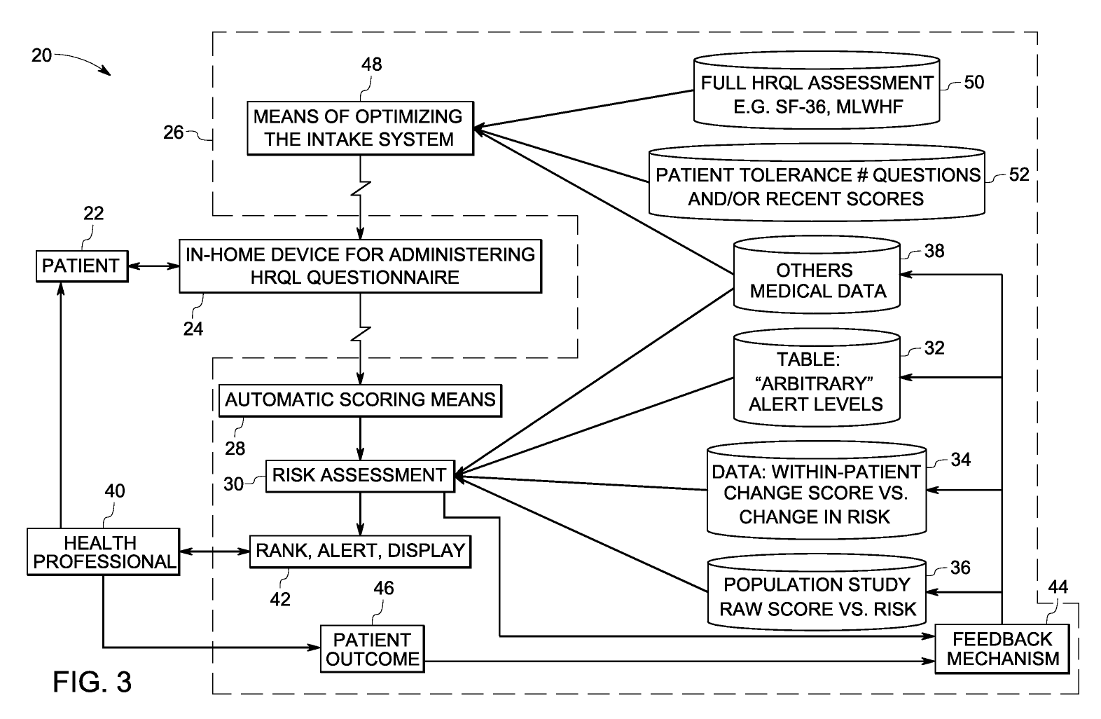

In certain embodiments, the system 10 may be configured to assess health related quality of life (HRQL) of an individual or a patient. For example, referring now to FIG. 3, a block diagram of a system 20 for assessing the health related quality of life (HRQL) of a patient 22 is illustrated. The system 20 includes one or more in-house portable devices 24 for periodically administering HRQL questionnaire by receiving a set of HRQL questions from a health assessment subsystem 26, querying the patient 22, and relaying the patient's responses to the health assessment subsystem 26. As noted above, the health assessment subsystem 16 may be remotely located from the portable devices 24. The health assessment subsystem 26 is configured to intelligently assess the HRQL of the patient 22 by automatically scoring the patient's responses to generate a health score via a scoring module 28 and translating the health score into a health risk assessment via a risk assessment module 30. The risk assessment module 30 translates the score into a risk assessment by referring to a predefined look-up table 32 (predefined cutoff health scores may be fixed at the physician's request which signifies health risk), a correlation data 34 between change in score and change in assessment based at least in part on one or more previous assessments, a correlation data 36 between score and assessment based on population study, and/or other medical data 38 related to the patient 22.

The health assessment subsystem 26 is further configured to display the health score and the corresponding health risk assessment to a health professional 40, rank the patient 22 based on the assessment, and alert the health professional 40 based on the rank and assessment via a display, rank and alert module 42. The health professional 40 may then advise or diagnose the patient 22 and provide required medical support (e.g., re-hospitalization in case of a acute medical condition) based on the health risk assessment and ranking. It should be noted that the health score and the corresponding health risk assessment may be used to continuously update the predefined look-up table 32, the correlation data 34 and 36, and the other medical data 38 related to the patient via a feedback module 44 as more patient records are accumulated. Further, patient outcome 46 after being diagnosed by the health professional 40 may be used to update the predefined look-up table 32, the correlation data 34 and 36, and the other medical data 38 related to the patient via a feedback module 44.

The health assessment subsystem 26 is configured to intelligently generate the HRQL questions for subsequent query based on the user response and the assessment via a question optimizer module 48. In particular, the questions are generated based on responses to previous queries, type of health assessment being carried out, previous health risk assessments, and/or other medical data related to the patient 22. The system is adapted to generate follow-up questions in some circumstances based on the user's responses. For example, if the answer to a question indicates a possible health concern, the system may immediately generate a one or more follow-up questions. Such series of questions is driven by a branching, hierarchical protocol based on any number of rules (e.g. If answer yes, then question 1, if answer no, then question 2) that may be adapted to a particular user's health history or to a particular health concern. The rules and questions may incorporate any type of personal or health related information. Below are a few examples.

### EXAMPLE 1

### Diabetic Patient

Question: How are you feeling today?
Answer: I am tired.
Question: Did you test your blood sugar today?
Answer: Yes.
If Yes, then Question: What was your blood sugar reading?
Answer: 250.
Question: Did you administer your insulin dose today?
Answer: No.
If No, then Question: When did you last administer your insulin dose?
If Yes, then: What dosage did you administer?

### EXAMPLE 2

### Patient with Pulmonary Heart Disease

Question: How are you feeling today?
Answer: Not well.
Question: Are you tired?
Answer: No.
If No, then Question: Are you having difficulty breathing?
Answer: Yes.
Question: Is your abdomen bloated?
Answer: No.
Question: Is your oxygen tank empty?
Answer: No.
In No, then Question: Are you using your oxygen supply today?
Answer: No, it is upstairs and my home care provider is not able to come by today so I cannot use it.

The number and type of rules, and hierarchical branching of these rules, is virtually limitless. The rules may also include rules that trigger an automatic alert to a caregiver depending on a particular response. For example, in the Example 2 above, if the response to the question, “Is your abdomen bloated” was yes, then the system may be programmed to sent an alert to a caregiver to check on the individual.

The system may be configured to generate a subsequent, but not necessarily immediate, series of questions based on a previous set of responses. If a given set of questions elicits the same responses for more than a predetermined number of days or inquiries, then the system will generate a entirely or partially different set of questions to either drill down into a given issue or possibly expand the scope of the questions. Not only does the adaptive system of questioning issue gather better information, the system also maintains the user's interest and compliance. The more personalized and responsive the questions, the better the results will be. The user is more engaged when the question and answer series are more like a dialogue rather than an interrogation. The system may also be configured to specifically ask questions intended to raise or keep up the user's spirits.

As noted above, the number of questions in the set may be predetermined (a fixed number of questions per query). Alternatively, the number of questions in the set may be intelligently determined for each query based on responses to previous queries, previous scores and assessments, other medical data related to the patient 22, and/or patient's tolerance to the number of questions. For example, extra scatter on a certain subscale might indicate if particular questions should be asked more frequently until the score or trend stabilizes. As illustrated, the parameters for determining the number of questions and/or generating the questions may be stored in one or more databases 38, 50 and 52.

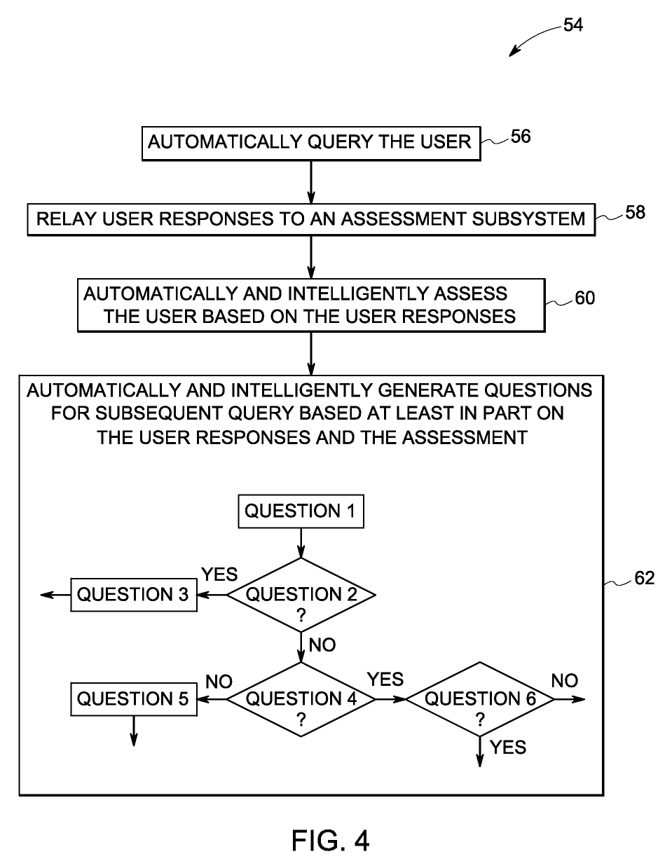

Referring now to FIG. 4, exemplary control logic 54 for assessing a user is depicted via a flowchart in accordance with aspects of the present technique. As illustrated in the flowchart, exemplary control logic 54 includes the steps of automatically querying the user at step 56, relaying user responses to an assessment subsystem at step 58, automatically and intelligently assessing the user based on the user responses at step 60, and automatically and intelligently generating questions for subsequent query based at least in part on the user responses and the assessment at step 62. The control logic 54 also includes the step of transmitting a set of questions from the assessment subsystem to one or more devices configured to query the user. As described above, the number of questions in the set may be predetermined or intelligently determined and the question may be intelligently generated based on responses to previous queries, type of assessment, previous assessments, user's tolerance to the number of questions, and/or other data related to the user. Additionally, the control logic 54 includes the step of displaying the score and the corresponding assessment to an evaluator, ranking the user based on the assessment, and alerting the evaluator based on the assessment.

The data gathering and assessment technique described in the various embodiments discussed above is automated, efficient, and cost-effective requiring minimum manual intervention. In particular, the HRQL assessment technique automatically administers the HRQL questionnaire periodically, evaluates health scores and corresponding risk, and notifies the health professionals, thereby reducing the stress on patient as well as the health professional. The health risk may be greatly mitigated by early and automatic detection of the condition of the patient leading to early treatment via re-hospitalization or an outpatient doctor visit. Additionally, the technique involves asking new and fewer numbers of questions that are based on a substantive and intelligent analysis of previous answers. The intuitive questions as well as fewer numbers of questions keep up the patient's interest and compliance while being administered the HRQL questionnaire so that their responses are that much more meaningful.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for assessing a user, the system comprising:
one or more devices for querying the user and relaying user responses to an assessment subsystem, the assessment subsystem configured to intelligently assess the user based on the user responses and to intelligently generate questions for subsequent query based at least in part on the user responses and the assessment.

2. The system of claim 1, wherein the assessment subsystem is remotely located from the one or more devices.

3. The system of claim 1, wherein the one or more devices is adapted to receive a set of questions from the assessment subsystem for querying the user.

4. The system of claim 3, wherein the number of questions in the set is based at least in part on one or more responses to previous queries, previous assessments, other data related to the user, user's tolerance to the number of questions, or a combination thereof.

5. The system of claim 3, wherein the questions in the set are based at least in part on one or more responses to previous queries, previous assessments, other data related to the user, user's tolerance to the questions, or a combination thereof.

6. The system of claim 1, wherein the questions are generated based at least in part on one or more types of health related information.

7. The system of claim 1, wherein the assessment subsystem is configured to intelligently assess the user by automatically scoring the user responses to generate a score and translating the score into an assessment.

8. The system of claim 7, wherein translating the score into the assessment comprises referring to a predefined look-up table, a correlation between change in score and change in assessment based at least in part on one or more previous assessments, a correlation between score and assessment based on population study, other data related to the user, or a combination thereof.

9. The system of claim 7, wherein the score and the corresponding assessment is updated in a database for subsequent reference.

10. The system of claim 7, wherein the assessment subsystem is further configured to display the score and the corresponding assessment to an evaluator, rank the user based on the assessment, and alert the evaluator based on the assessment.

11. A system for assessing health related quality of life (HRQL) of an individual, the system comprising:
one or more devices for querying the individual and relaying individual responses to an assessment subsystem, the assessment subsystem configured to intelligently assess the HRQL of the individual by automatically scoring the individual responses to generate a score and translating the score into a risk assessment.

12. The system of claim 11, wherein the assessment subsystem is remotely located from the one or more devices.

13. The system of claim 11, wherein the one or more devices is adapted to receive a set of HRQL questions from the assessment subsystem for querying the individual, and wherein the number of questions and the questions in the set are based at least in part on one or more responses to previous queries, previous risk assessments, other medical data related to the individual, individual tolerance to the number of questions and the questions, or a combination thereof.

14. The system of claim 11, wherein the assessment subsystem is configured to intelligently generate questions for subsequent query based at least in part on one or more responses to previous queries, type of risk assessment, previous risk assessments, other medical data related to the user, or a combination thereof.

15. The system of claim 11, wherein translating the score into the risk assessment comprises using one or more rules based on one or more references selected from a group consisting of: a predefined look-up table, a correlation between change in score and change in risk assessment based at least in part on one or more previous risk assessments, a correlation between score and risk assessment based on population study, and other medical data related to the individual.

16. The system of claim 11, wherein the score and the corresponding risk assessment is updated in a database for subsequent reference.

17. The system of claim 11, wherein the assessment subsystem is further configured to display the score and the corresponding risk assessment to a health professional, rank the user based on the risk assessment, and alert the health professional based on the risk assessment.

18. A method of assessing a user, the method comprising:
automatically querying the user and relaying user responses to an assessment subsystem; and
automatically and intelligently assessing the user based on the user responses and generating questions for subsequent query based at least in part on the user responses and the assessment.

19. The method of claim 18, further comprising transmitting a set of questions from the assessment subsystem to one or more devices configured to query the user, wherein the number of questions and the questions in the set are based at least in part on one or more responses to previous queries, previous assessments, other data related to the user, user's tolerance to the number of questions and the questions, or a combination thereof.

20. The method of claim 18, wherein automatically and intelligently generating questions comprises generating questions based at least in part on one or more types of health related information.

21. The method of claim 18, wherein intelligently assessing the user comprises automatically scoring the user responses to generate a score and translating the score into an assessment.

22. The method of claim 21, wherein translating the score into the assessment comprises referring to a predefined look-up table, a correlation between change in score and change in assessment based at least in part on one or more previous assessments, a correlation between score and assessment based on population study, other data related to the user, or a combination thereof.

23. The method of claim 21, further comprising updating the score and the corresponding assessment in a database for subsequent reference.

24. The method of claim 21, further comprising displaying the score and the corresponding assessment to an evaluator, ranking the user based on the assessment, and alerting the evaluator based on the assessment.

25. A method of assessing health related quality of life (HRQL) of an individual, the method comprising:
automatically querying the individual and relaying individual responses to an assessment subsystem; and
automatically and intelligently assessing the HRQL of the individual by automatically scoring the individual responses to generate a score and translating the score into a risk assessment.

26. The method of claim 25, further comprising transmitting a set of HRQL questions from the assessment subsystem to one or more devices configured to query the individual, wherein the number of questions and the questions in the set are based at least in part on one or more responses to previous queries, previous risk assessments, other medical data related to the individual, individual tolerance to the number of questions and the questions, or a combination thereof.

27. The method of claim 25, further comprising intelligently generating questions for subsequent query based at least in part on one or more responses to previous queries, type of risk assessment, previous risk assessments, other medical data related to the user, or a combination thereof.

28. The method of claim 25, wherein translating the score into the risk assessment comprises using one or more rules based on one or more references selected from a group consisting of: a predefined look-up table, a correlation between change in score and change in risk assessment based at least in part on one or more previous risk assessments, a correlation between score and risk assessments based on population study, and other medical data related to the individual.

28. The method of claim 25, further comprising updating the score and the corresponding risk assessments in a database for subsequent reference.

30. The method of claim 25, further comprising displaying the score and the corresponding risk assessments to a health professional, ranking the user based on the risk assessment, and alerting the health professional based on the risk assessment.
